(19) United States
(12) Patent Application Publication
(10) Pub. No.: US 2021/0303223 A1
(43) Pub. Date: Sep. 30, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Kenji FUKUMURA, Kanagawa (JP)

(73) Assignee: FUJIFILM Business Innovation Corp., Tokyo (JP)

(21) Appl. No.: 16/939,068

(22) Filed: Jul. 27, 2020

(30) Foreign Application Priority Data
Mar. 26, 2020 (JP) 2020-055996

(51) Int. Cl. G06F 3/12; G06F 8/65

(52) U.S. Cl. CPC G06F 3/123; G06F 8/65

(57) ABSTRACT

An information processing apparatus includes a processor configured to, when an update request to update control information is received from a target apparatus, ask, in a specific case, a management apparatus about whether or not there is the control information for the update request. The management apparatus manages the control information on the Internet.

### CROSS-REFERENCE TO RELATED APPLICATIONS

This application is based on and claims priority under 35 USC 119 from Japanese Patent Application No. 2020-055996 filed Mar. 26, 2020.

### BACKGROUND

### (i) Technical Field

The present disclosure relates to an information processing apparatus and a non-transitory computer readable medium.

### (ii) Related Art

Recently, a digital multifunction device has been proposed. Such a digital multifunction device updates the programs of its image forming apparatus automatically without depending on knowledge and know-how of users and service men (for example, see Japanese Unexamined Patent Application Publication No. 2006-127393).

A digital multifunction device described in Japanese Unexamined Patent Application Publication No. 2006-127393 obtains a file including information about the latest firmware version through the file transfer protocol (FTP) from a server on the Internet. Then, the digital multifunction device obtains information about a version, in which the operations are guaranteed, through FTP on the basis of the obtained firmware version information, and further obtains firmware data of the version through FTP to update the firmware to the version automatically.

Depending on the location where an apparatus is disposed, the apparatus may be prohibited from being connected to the Internet. This case may lead to inefficiency if, on every reception of an update request from the apparatus, control information is downloaded from a server on the Internet through a relay server.

### SUMMARY

Aspects of non-limiting embodiments of the present disclosure relate to an information processing apparatus and a non-transitory computer readable medium which, when an apparatus is to download control information, reduce opportunities of transmitting inquiries to a management apparatus, which manages control information on the Internet, compared with the case in which no limitation is placed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, when an update request to update control information is received from a target apparatus, ask, in a specific case, a management apparatus about whether or not there is the control information for the update request. The management apparatus manages the control information on the Internet.

### BRIEF DESCRIPTION OF THE DRAWINGS

Exemplary embodiments of the present disclosure will be described in detail based on the following figures, wherein:

FIG. 1 is a diagram illustrating an exemplary configuration of an information processing system according to a first exemplary embodiment of the present disclosure;

FIG. 2 is a block diagram illustrating an exemplary control system of an apparatus according to the first exemplary embodiment;

FIG. 3 is a block diagram illustrating an exemplary control system of a relay server;

FIG. 4 is a diagram illustrating exemplary update mapping information;

FIG. 5 is a diagram illustrating exemplary firmware information;

FIGS. 6A to 6C are diagrams illustrating exemplary screens displayed on an operation display unit of an apparatus;

FIG. 7 is a sequence chart of exemplary operations of an information processing system;

FIG. 8 is a sequence chart of exemplary operations of an information processing system;

FIG. 9 is a sequence chart of exemplary operations of an information processing system;

FIG. 10 is a sequence chart of exemplary operations of an information processing system;

FIG. 11 is a flowchart of exemplary operations of a relay server according to the first exemplary embodiment;

FIG. 12 is a diagram illustrating an exemplary configuration of an information processing system according to a second exemplary embodiment of the present disclosure;

FIG. 13 is a block diagram illustrating an exemplary control system of an apparatus according to the second exemplary embodiment;

FIG. 14 is a diagram illustrating an exemplary FW-update prohibited apparatus list; and

FIG. 15 is a flowchart of exemplary operations of a relay server according to the second exemplary embodiment.

### DETAILED DESCRIPTION

Embodiments of the present disclosure will be described below by referring to the drawings. In the figures, components having substantially the same functions are designated with the same reference numerals, and repeated description will be avoided.

### Summary of Embodiment

An information processing apparatus according to the present embodiment has a processor which, when an update request to update control information is received from a target apparatus, asks, in specific cases, a management apparatus, which manages control information on the Internet, about whether or not there is the control information for the update request.

The target apparatus is an apparatus which has transmitted the update request. Examples of the control information include firmware and application. Firmware is a program for operating hardware of an apparatus, and is downloaded to the apparatus for use.

### First Embodiment

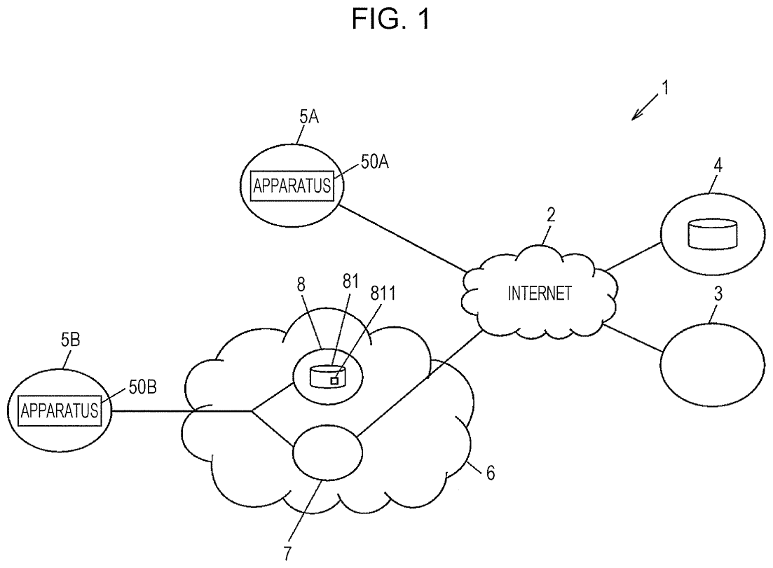

FIG. 1 is a diagram illustrating an exemplary configuration of an information processing system according to a first embodiment of the present disclosure. An information processing system 1 includes a management server 3 and a download server 4, which are disposed on the Internet 2, a first intranet 5A connected to the Internet 2, and a second intranet 5B connected to the Internet 2 over a relay network 6.

Multiple apparatuses 50A are connected to the first intranet 5A. Multiple apparatuses 50B are connected to the second intranet 5B. In the description below, the apparatuses 50A and 50B may be collectively called the “apparatuses 50”.

The first intranet 5A is constructed, for example, in a company. The second intranet 5B is constructed in a specific client, for example, an administrative agency such as a city office. The specific client uses, for example, apparatuses prohibited from being connected to the Internet. The apparatuses 50B disposed for the specific client are exemplary specific apparatuses.

The management server 3 and the download server 4 are exemplary management apparatuses. The management server 3 and the download server 4 may be connected to each other over an intranet, or all of them may be configured as a physically-single server.

The management server 3 manages, for example, the operating states of the apparatuses 50 and firmware used in the apparatuses 50. In response to an inquiry from an apparatus 50A on the first intranet 5A, the management server 3 transmits, to the apparatus 50A, a reply about the uniform resource locator (URL) indicating the storage location of the latest firmware in the download server 4. Firmware is exemplary control information.

The download server 4 on the Internet 2 is a software repository storing, for example, firmware (hereinafter also referred to as “FW”). In response to an access from an apparatus 50A on the first intranet 5A, the download server 4 causes the firmware or the like to be downloaded.

A relay server 7 and a download server 8 are connected to the relay network 6.

When an update request to update firmware is received from an apparatus 50B on the second intranet 5B, the relay server 7 asks, in the specific cases, the management server 3 on the Internet 2 about whether or not there is the firmware for the update request.

Examples of the specific cases are as follows:

(a) the case in which a request to update firmware is received after a predetermined time elapses since an update of firmware information 811 (see FIG. 5) stored in the download server 8;

(b) the case in which the firmware for the request to update firmware is not stored in the download server 8;

(c) the case in which, in addition to (b), the number of update requests from the apparatuses of the same model as that of the target apparatus is equal to or less than a certain number (for example, one), where the apparatuses of the same model indicate, for example, apparatuses whose identification information such as a model code indicating the type of the apparatus is the same;

(d) the case in which, in addition to (b), the number of update requests from the target apparatus is equal to or less than a certain number (for example, one).

The download server 8 on the relay network 6 is a software repository storing, for example, firmware. The download server 8 is disposed at a place where the download server 8 may be accessed by the specific client not over the Internet 2. In response to an access from an apparatus 50B on the second intranet 5B, the download server 8 causes the firmware or the like to be downloaded. The download server 8 accesses the download server 4 on the Internet 2 through the relay server 7 at regular time intervals, and obtains firmware information. Thus, the download server 8 updates the firmware information 811 stored in a storage unit 81 of the download server 8.

### Configuration of an Apparatus

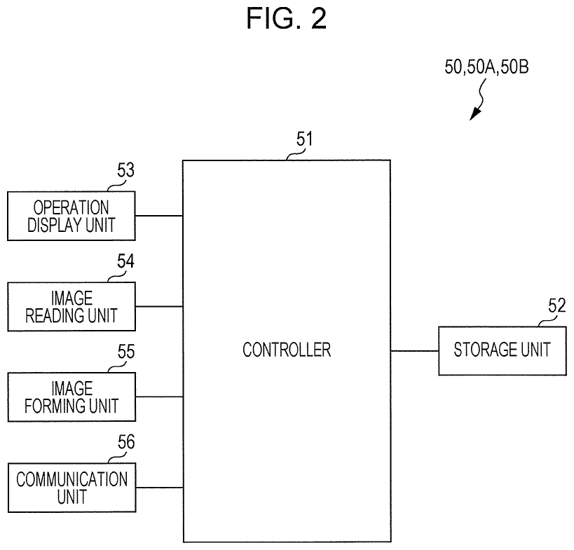

FIG. 2 is a block diagram illustrating an exemplary control system of each apparatus 50. The apparatus 50 is, for example, a multifunction device having the scan function, the print function, the copy function, the electronic mail function, the facsimile reception/transmission function, and the like. A multifunction device is an exemplary image forming apparatus.

The apparatus 50 includes a controller 51, which controls the units of the apparatus 50 and to which a storage unit 52, an operation display unit 53, an image reading unit 54, an image forming unit 55, a communication unit 56, and the like are connected.

The controller 51 includes a processor such as a central processing unit (CPU) and an interface. The processor executes programs stored in the storage unit 52, thus controlling the units of the apparatus 50 and accessing the relay server 7 and the download servers 4 and 8.

That is, at an update request timing, which is stored in the storage unit 52 and at which a request for update is to be transmitted, the controller 51 transmits a request to update firmware (hereinafter also referred to as a “FW update request”) to the relay server 7. The update request timing is defined by the management server 3. The FW update request includes the product name of the firmware and the current firmware version. The FW update request is an exemplary update request.

The controller 51 accesses the download servers 4 and 8, downloads firmware, stores the firmware in the storage unit 52, and updates the firmware.

The storage unit 52, which includes a read only memory (ROM), a random access memory (RAM), a hard disk, and the like, stores programs such as firmware and various types of information such as the update request timing.

The operation display unit 53 receives input of information and displays information. The operation display unit 53, which is, for example, a touch panel display, has a configuration in which a touch panel overlies a display such as a liquid-crystal display.

The image reading unit 54 includes an automatic feeder, which is disposed on a document platen, and a scanner which reads a document image optically from a document disposed on the document platen or a document fed by the automatic feeder.

The image forming unit 55 forms an image, for example, by using an electrophotographic system or an inkjet system on a sheet supplied from a paper cassette, and generates printed material.

The communication unit 56 communicates with external apparatuses, such as a user terminal, the management server 3, the download servers 4 and 8, and the relay server 7, over a network, such as a local area network (LAN) or the Internet 2.

### Configuration of the Relay Server

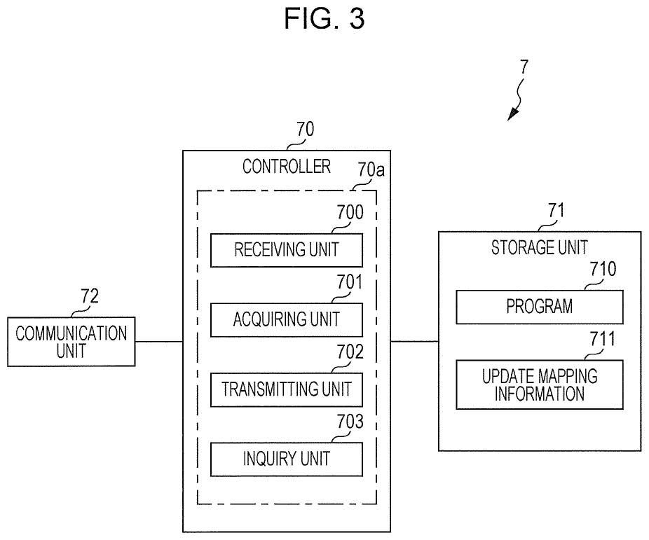

FIG. 3 is a block diagram illustrating an exemplary control system of the relay server 7. The relay server 7 includes a controller 70, which controls the units of the relay server 7 and to which a storage unit 71, a communication unit 72, and the like are connected. The storage unit 71 is an exemplary storage unit of an information processing apparatus.

The controller 70 includes a processor 70a such as a CPU and an interface. The processor 70a executes a program 710 stored in the storage unit 71, functioning as a receiving unit 700, an acquiring unit 701, a transmitting unit 702, an inquiry unit 703, and the like. The units 700 to 703 will be described in detail below.

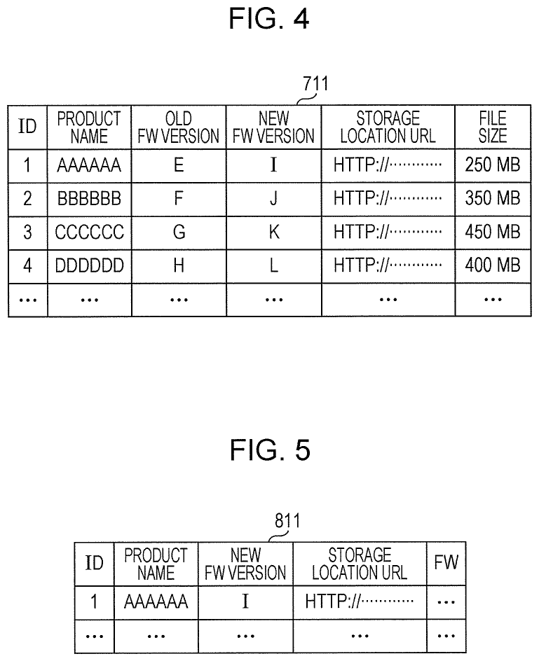

The storage unit 71, which includes a ROM, a RAM, a hard disk, and the like, stores the program 710 and various types of information such as update mapping information 711 (see FIG. 4). The update mapping information 711 is exemplary update information.

FIG. 4 is a diagram illustrating exemplary update mapping information 711. The update mapping information 711 has multiple items, such as “ID”, “PRODUCT NAME”, “OLD FW VERSION”, “NEW FW VERSION”, “STORAGE LOCATION URL”, and “FILE SIZE”.

In “ID”, IDs as exemplary product identification information for identifying product names are recorded. In “PRODUCT NAME”, firmware names are recorded. In “OLD FW VERSION”, old versions (for example, version numbers) of the firmware are recorded. In “NEW FW VERSION”, new versions (for example, version numbers) of the firmware, which are updates from their old versions, are recorded. In “STORAGE LOCATION URL”, URLs in the download server 8 on the relay network 6 are recorded as the storage locations of the new-version firmware. In “FILE SIZE”, the file sizes of the new-version firmware are recorded. The firmware names are exemplary identification information of the control information. The version numbers are exemplary version information. The URLs are exemplary storage location information.

FIG. 5 is a diagram illustrating exemplary firmware information 811 stored in the storage unit 81 of the download server 8. The firmware information 811 has multiple items, such as “ID”, “PRODUCT NAME”, “NEW FW VERSION”, “STORAGE LOCATION URL”, and “FW”. The items, “ID”, “PRODUCT NAME”, “NEW FW VERSION”, and “STORAGE LOCATION URL”, have the same meanings as those of the update mapping information 711 in FIG. 4. In “FW”, the new-version firmware is stored.

The units 700 to 703 of the relay server 7 will be described.

The receiving unit 700 receives FW update requests and various notifications which are transmitted from the apparatuses 50B.

The acquiring unit 701 accesses the management server 3 at regular time intervals (for example once a week) to obtain update mapping information, and stores the obtained update mapping information in the storage unit 71 to update the update mapping information 711. The acquiring unit 701 accesses the download server 4 at regular time intervals (for example, once a week) to obtain firmware, and stores the obtained firmware in the storage unit 81 of the download server 8 to update the firmware information 811.

On the basis of the product name and the firmware version which are included in a FW update request transmitted from an apparatus 50B on the second intranet 5B, the acquiring unit 701 acquires the version in “NEW FW VERSION” and the URL in “STORAGE LOCATION URL”, which correspond to the product name, in the update mapping information 711.

In accordance with a FW update request from an apparatus 50B on the second intranet 5B, the transmitting unit 702 generates file information including a new version, a URL, and a file size which are acquired by the acquiring unit 701, and transmits the file information to the apparatus 50B.

In certain cases, the transmitting unit 702 notifies an apparatus 50B, which has transmitted a FW update request, or the management server 3 of an error. The error is exemplary information indicating that the update request is invalid.

The following case is regarded as an exemplary specific case: there is no new version, which corresponds to the version included in a received FW update request, in the update mapping information 711; and the FW update request is the first FW update request for the version, after an update of the update mapping information 711, from the apparatuses 50B of the same model including the apparatus 50B having transmitted the FW update request. In this case, the inquiry unit 703 asks the management server 3 about whether there is a new version of the firmware to which an update is to be done.

### Operations of the Information Processing System

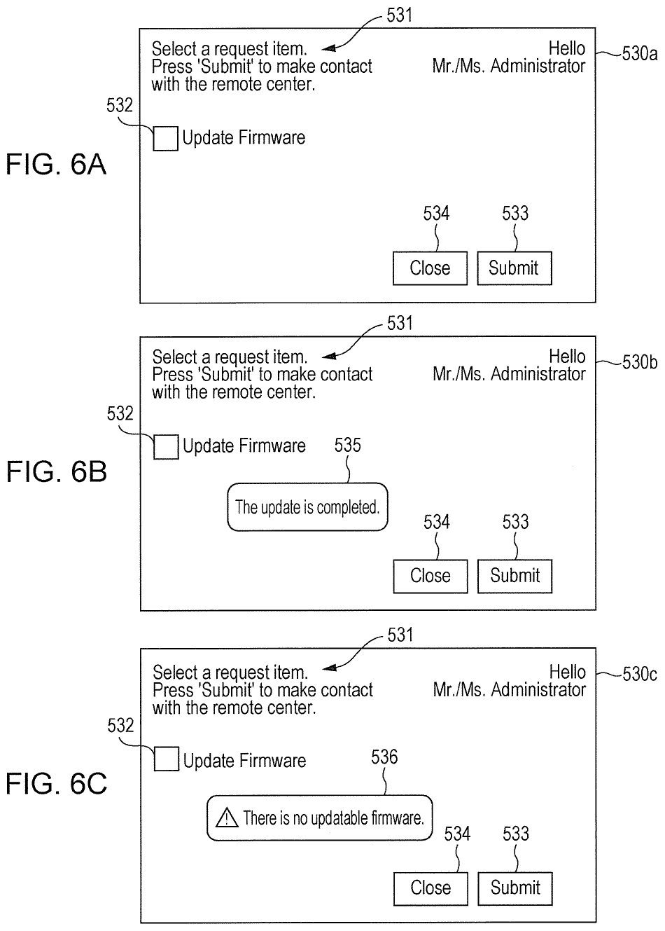

Exemplary operations of the information processing system 1 according to the first exemplary embodiment will be described by referring to FIGS. 6A to 11. The case in which the firmware of an apparatus 50B connected to the second intranet 5B is to be updated will be described.

(1) The First Case of Success of an Update of Firmware (without an Inquiry to the Management Server 3)

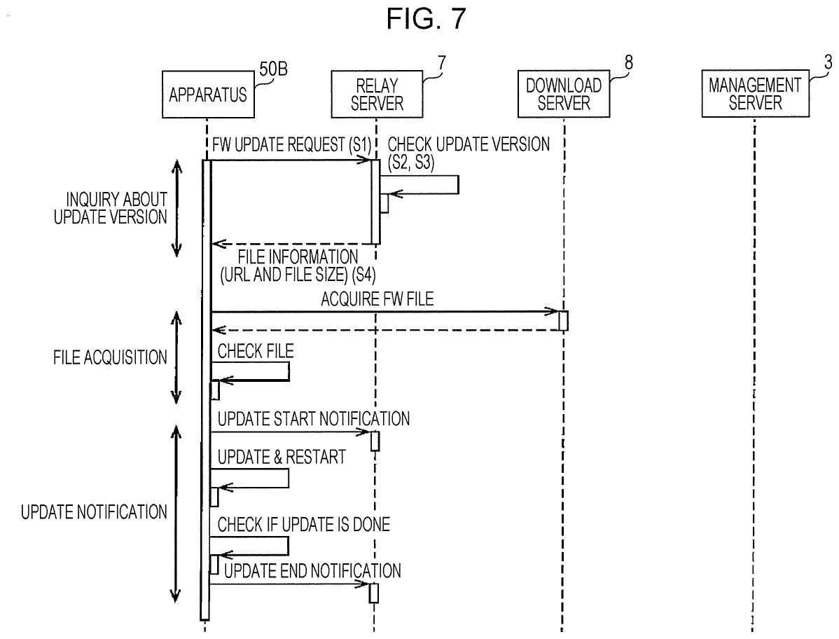

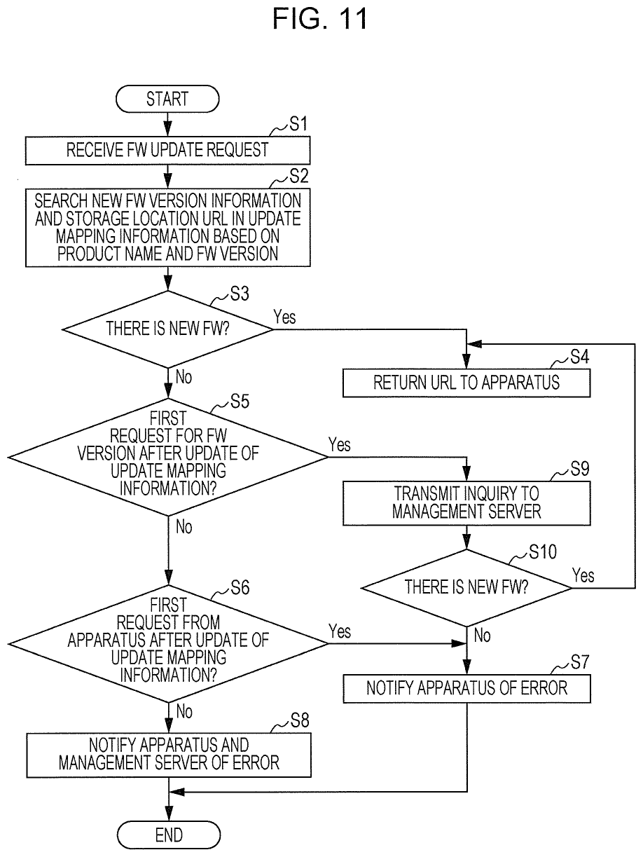

The first case of success of an update of firmware will be described by referring to the screens in FIGS. 6A to 6B, the sequence chart in FIG. 7, and the flowchart in FIG. 11.

At a timing of updating firmware, the controller 51 of an apparatus 50B displays, on the operation display unit 53, a firmware update screen for performing operations necessary to update firmware.

FIG. 6A is a diagram illustrating an exemplary firmware update screen. A firmware update screen 530a has a message 531, “Select a request item. Press ‘Submit’ to make contact with, the remote center,” a checkbox 532 for selecting an update of firmware, a “Submit” button 533 for doing an update of firmware, and a “Close” button 534 for stopping execution of an update of firmware. The remote center corresponds to the management server 3 or the relay server 7 in the first exemplary embodiment.

An administrator selects the check button 532 on the firmware update screen 530a, and operates the “Submit” button 533.

As illustrated in FIG. 7, the controller 51 of the apparatus 50B transmits a FW update request to the relay server 7. The FW update request includes the product name and the current firmware version.

As illustrated in FIGS. 7 and 11, the receiving unit 700 of the relay server 7 receives the FW update request (S1).

On the basis of the product name and the firmware version included in the FW update request, the acquiring unit 701 of the relay server 7 searches the versions in “NEW FW VERSION” and the URLs in “STORAGE LOCATION URL” in the update mapping information 711 (S2).

It is determined whether or not there is a new firmware version (hereinafter referred to as a new version) corresponding to the obtained product name and firmware version (hereinafter referred to as the old version) (S3). If there is a new version (Yes in S3), the acquiring unit 701 acquires the new version, the URL, and the file size from the update mapping information 711.

The transmitting unit 702 generates file information including the new version, the URL, and the file size, and transmits the file information to the apparatus 50B (S4). For example, if the old version of the product name, “AAAAAA”, is “E”, there is a new version, “I”, corresponding to the old version. Thus, file information including the new version, “I”, the URL, and the file size (250 MB) is generated, and is transmitted to the apparatus 50B.

On the basis of the received file information, the controller 51 of the apparatus 50B accesses the download server 8 to download a file of the firmware (hereinafter also referred to as a FW file), and checks if the FW file has a version to which an update is to be done.

If the FW file has a version to which an update is to be done, the controller 51 of the apparatus 50B starts updating the firmware, and transmits an update start notification to the relay server 7.

The controller 51 of the apparatus 50B performs the update process, restarts, and checks if the update is completed. If the update is completed, the controller 51 transmits an update end notification to the relay server 7.

The controller 51 of the apparatus 50B displays a firmware update end screen on the operation display unit 53.

FIG. 6B is a diagram illustrating an exemplary firmware update end screen. A firmware update end screen 530b displays a message 535, “The update is completed.”

(2) The Second Case of Success of an Update of Firmware (with an Inquiry to the Management Server 3)

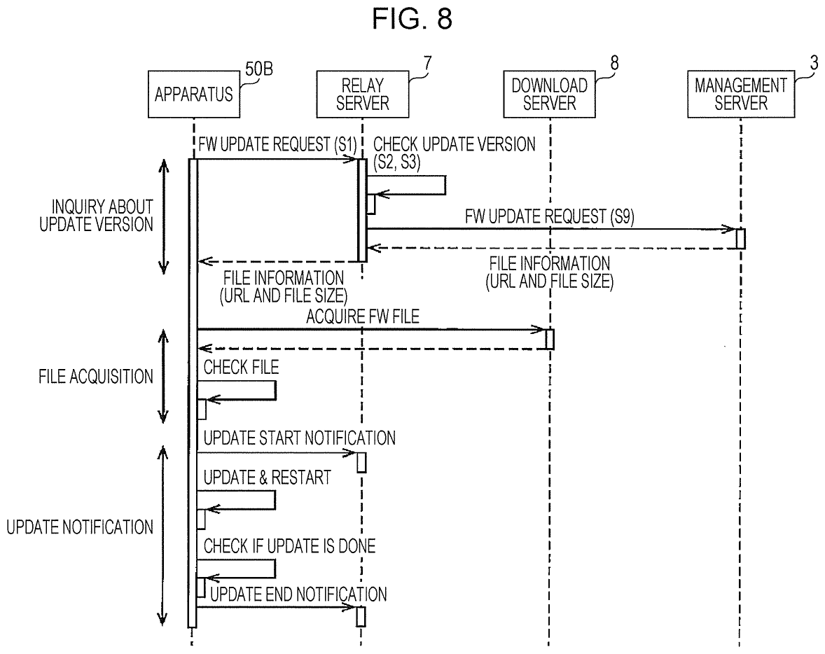

The second case of success of an update of firmware will be described by referring to the screens in FIGS. 6A to 6B, the sequence chart in FIG. 8, and the flowchart in FIG. 11.

An administrator selects the check button 532 on the firmware update screen 530a illustrated in FIG. 6A, and operates the “Submit” button 533. Then, the controller 51 of the apparatus 50B transmits a FW update request to the relay server 7 as illustrated in FIG. 8.

The receiving unit 700 of the relay server 7 receives the FW update request as illustrated in FIGS. 8 and 11 (S1).

On the basis of the product name and the firmware version included in the FW update request, the acquiring unit 701 of the relay server 7 searches “NEW FW VERSION” and “STORAGE LOCATION URL” in the update mapping information 711 (S2).

The acquiring unit 701 determines whether or not there is a new version (S3). If there is no new version (No in S3), the inquiry unit 703 determines whether or not the FW update request is the first FW update request, in a predetermined time after an update of the update mapping information 711, from the apparatuses 50B of the same model including the apparatus 50B having transmitted the FW update request (S5). That is, if a different apparatus 50B of the same model as that of the apparatus 50B has transmitted a FW update request, it is determined that the FW update request is not the first FW update request.

If the FW update request is the first FW update request from the apparatuses 50B of the same model (Yes in S5), this case is regarded as an exemplary specific case, and the inquiry unit 703 asks the management server 3 about whether or not there is a version of the firmware to which an update is to be done (S9).

The management server 3 determines whether or not there is a version of the firmware to which an update is to be done (S10). If there is a version of the firmware to which an update is to be done (Yes in S10), the management server 3 generates file information of the firmware, and transmits the file information to the relay server 7. The relay server 7 transmits the file information, which has been received from the management server 3, to the apparatus 50B (S4).

As described by using FIG. 7, for example, the controller 51 of the apparatus 50B obtains a FW file, transmits an update start notification, performs the update process, and transmits an update end notification.

(3) The First Case of Failure of an Update of Firmware (without an Inquiry to the Management Server 3)

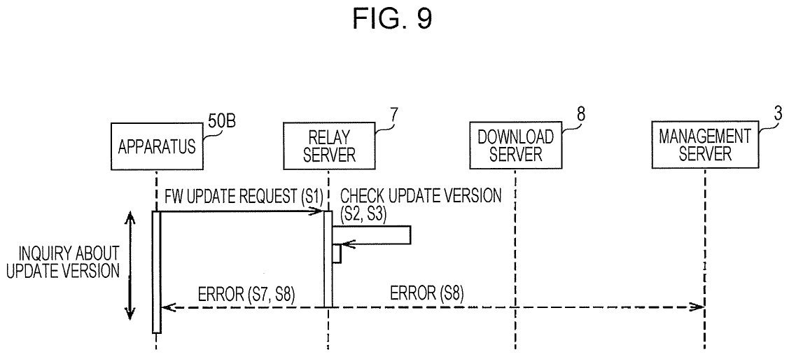

The first case of failure of an update of firmware will be described by referring to the screens in FIGS. 6A to 6C, the sequence chart in FIG. 9, and the flowchart in FIG. 11.

An administrator selects the check button 532 on the firmware update screen 530a illustrated in FIG. 6A, and operates the “Submit” button 533. Then, the controller 51 of the apparatus 50B transmits a FW update request to the relay server 7 as illustrated in FIG. 9.

As illustrated in FIGS. 9 and 11, the receiving unit 700 of the relay server 7 receives the FW update request (S1).

On the basis of the product name and the firmware version included in the FW update request, the acquiring unit 701 of the relay server 7 searches “NEW FW VERSION” and “STORAGE LOCATION URL” in the update mapping information 711 (S2).

The acquiring unit 701 determines whether or not there is a new version (S3). If there is not a new version (No in S3), the inquiry unit 703 determines whether or not the FW update request is the first FW update request for the version, after an update of the update mapping information 711, from the apparatuses 50B of the same model including the apparatus 50B having transmitted the FW update request (S5).

If the FW update request is not the first FW update request from the apparatuses 50B of the same model (No in S5), the inquiry unit 703 determines whether or not the FW update request is the first FW update request from the apparatus 50B after the update of the update mapping information 711 (S6).

If the FW update request is the first FW update request from the apparatus 50B (Yes in S6), the transmitting unit 702 notifies the apparatus 50B of an error (S7).

If the FW update request is not the first FW update request from the apparatus 50B (No in S6), the transmitting unit 702 notifies the apparatus 50B and the management server 3 of an error (S8).

(4) The Second Case of Failure of an Update of Firmware (with an Inquiry to the Management Server 3)

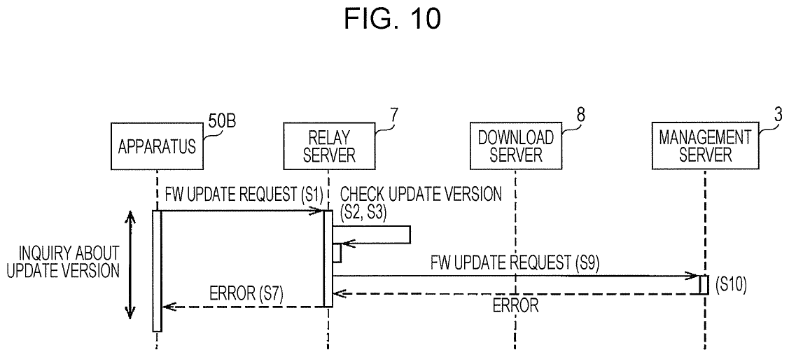

The second case of failure of an update of firmware will be described by referring to the screens in FIGS. 6A to 6C, the sequence chart in FIG. 10, and the flowchart in FIG. 11.

An administrator selects the check button 532 on the firmware update screen 530a illustrated in FIG. 6A, and operates the “Submit” button 533. Then, the controller 51 of the apparatus 50B transmits a FW update request to the relay server 7 as illustrated in FIG. 10.

As illustrated in FIGS. 10 and 11, the receiving unit 700 of the relay server 7 receives the FW update request (S1).

On the basis of the product name and the firmware version included in the FW update request, the acquiring unit 701 of the relay server 7 searches “NEW FW VERSION” and “STORAGE LOCATION URL” in the update mapping information 711 (S2).

It is determined whether or not there is a new version (S3). If there is no new version (No in S3), it is determined whether or not the FW update request is the first FW update request for this version, after an update of the update mapping information 711, from the apparatuses 50B of the same model including the apparatus 50B having transmitted the FW update request (S5).

If the FW update request is the first FW update request from the apparatuses 50B of the same model (Yes in S5), the inquiry unit 703 transmits the FW update request to the management server 3 for inquiry (S9).

The management server 3 determines whether or not there is a new version (S10). If there is a new version of the firmware (Yes in S10), the transmitting unit 702 transmits file information of the firmware to the apparatus 50B through the relay server 7 (S4).

If there is no new version (No in S10), the transmitting unit 702 notifies the apparatus 50B of an error (S7).

The controller 51 of the apparatus 50B displays a firmware update failure screen on the operation display unit 53.

FIG. 6C is a diagram illustrating an exemplary firmware update failure screen. A firmware update failure screen 530c displays a message 536, “There is no updatable firmware.”

The apparatus 50A on the first intranet 5A transmits a FW update request to the management server 3 not through the relay server 7. If there is a version of the firmware to which an update is to be done, the management server 3 generates file information including the URL of the firmware, and transmits the file information to the apparatus 50A. The apparatus 50A accesses the download server 4 on the Internet 2 to download the firmware. If there is no version of the firmware to which an update is to be done, the management server 3 notifies the apparatus 50A of an error.

### Second Embodiment

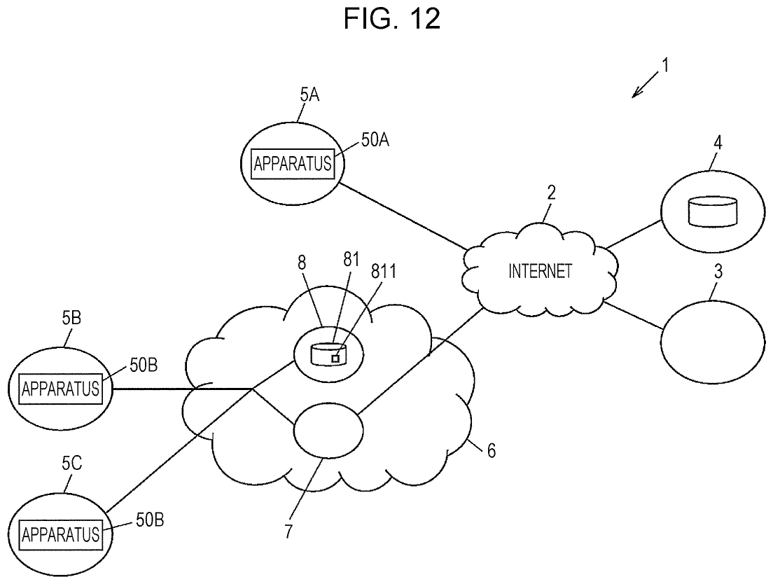

FIG. 12 is a diagram illustrating an exemplary configuration of an information processing system according to a second exemplary embodiment of the present disclosure. The first exemplary embodiment handles apparatuses 50B which are disposed for a specific client and whose firmware is allowed to be updated. In addition to such apparatuses 50B, the second exemplary embodiment handles apparatuses 50B whose firmware is not allowed to be updated. Points different from those in the first exemplary embodiment will be described.

The information processing system 1 includes the management server 3 and the download server 4 which are disposed on the Internet 2, the first intranet 5A connected to the Internet 2, and the second intranet 5B and a third intranet 5C which are connected to the Internet 2 over the relay network 6.

The apparatuses 50A are connected to the first intranet 5A. Multiple apparatuses 50B are connected to the second intranet 5B and the third intranet 5C. In the description below, the apparatuses 50A and 50B may be collectively called “apparatuses 50”.

The first intranet 5A is constructed, for example, in a company. The second intranet 5B is constructed in a first specific client, for example, an administrative agency such as a city office. The third intranet 5C is constructed in a second specific client, for example, an administrative agency such as a city office. The first specific client uses, for example, apparatuses prohibited from being connected to the Internet. The second specific client uses, for example, apparatuses which are prohibited from being connected to the Internet and which have control information prohibited from being updated. The apparatuses 50B disposed for the first specific client and the second specific client are exemplary specific apparatuses.

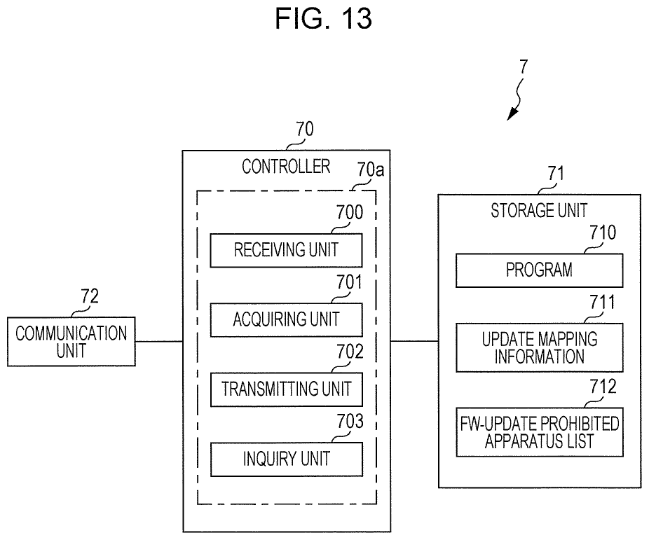

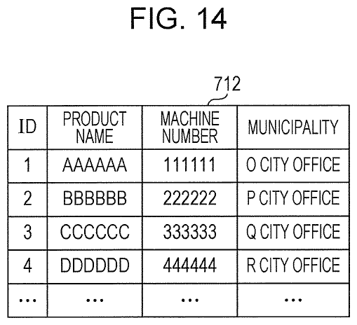

FIG. 13 is a block diagram illustrating an exemplary control system of the relay server 7 according to the second exemplary embodiment. As in the first exemplary embodiment, the relay server 7 includes the controller 70, the storage unit 71, and the communication unit 72. As in the first exemplary embodiment, the storage unit 71 stores the program 710 and the update mapping information 711 (see FIG. 4), and also stores a FW-update prohibited apparatus list 712 (see FIG. 14).

FIG. 14 is a diagram illustrating an exemplary FW-update prohibited apparatus list 712. The FW-update prohibited apparatus list 712 has multiple items, such as “ID”, “PRODUCT NAME”, “MACHINE NUMBER”, and “MUNICIPALITY”. As in the update mapping information 711, in “ID”, IDs for identifying product names are recorded. As in the update mapping information 711, in “PRODUCT NAME”, firmware names are recorded. In “MACHINE NUMBER”, numbers for identifying individual apparatuses 50 are recorded. In “MUNICIPALITY”, the names of municipalities where the apparatuses 50 are disposed are recorded.

The units 700 to 703 of the relay server 7 will be described.

As in the first exemplary embodiment, the receiving unit 700 receives FW update requests and various notifications which are transmitted from the apparatuses 50B.

As in the first exemplary embodiment, the acquiring unit 701 updates the update mapping information 711 and the firmware information 811. On the basis of the product name and the firmware version included in a FW update request transmitted from an apparatus 50B on the second intranet 5B or an apparatus 50B on the third intranet 5C, the acquiring unit 701 acquires the version in “NEW FW VERSION” and the URL in “STORAGE LOCATION URL”, which correspond to the product name, in the update mapping information 711.

The transmitting unit 702 generates file information including the new version, the URL, and the file size which are acquired by the acquiring unit 701 in accordance with a FW update request from an apparatus 50B on the second intranet 5B or an apparatus 50B on the third intranet 5C, and transmits the file information to the apparatus 50B.

In certain cases, the transmitting unit 702 notifies an apparatus 50B, which has transmitted a FW update request, or the management server 3 of an error. The error is exemplary information indicating that the update request is invalid.

For example, when an apparatus 50B is a specific apparatus whose firmware is prohibited from being updated, that is, when the apparatus 50B is connected to the third intranet 5C, even if the download server 4 on the Internet 2 or the download server 8 on the relay network 6 stores the corresponding firmware, the transmitting unit 702 notifies the apparatus 50B of an error.

When a FW update request is transmitted from an apparatus 50B on the second intranet 5B, as in the first exemplary embodiment, the inquiry unit 703 may transmit an inquiry to the management server 3. In contrast, when a FW update request is transmitted from an apparatus 50B on the third intranet 5C, the inquiry unit 703 does not transmit an inquiry to the management server 3.

### Operations of the Second Exemplary Embodiment

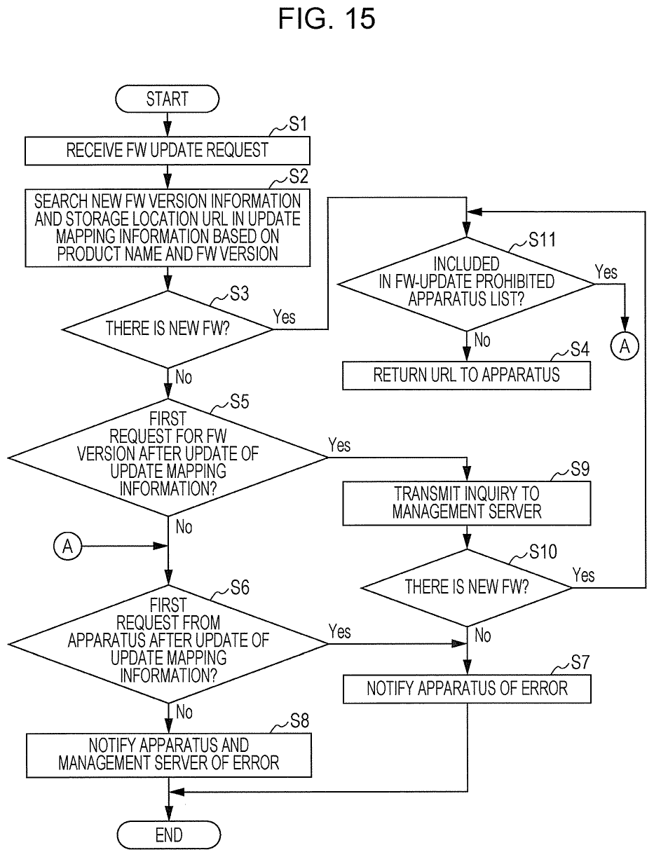

Exemplary operations of the information processing system 1 according to the second exemplary embodiment will be described. FIG. 15 is a flowchart of exemplary operations of the relay server 7 according to the second exemplary embodiment.

An administrator selects the check button 532 on the firmware update screen 530a illustrated in FIG. 6A, and operates the “Submit” button 533. Then, as illustrated in FIG. 10, the controller 51 of the apparatus 50B transmits a FW update request to the relay server 7. The FW update request includes the machine number, the product name, and the current firmware version.

On the basis of the product name and the firmware version included in the FW update request, the acquiring unit 701 of the relay server 7 searches the versions in “NEW FW VERSION” and the URLs in “STORAGE LOCATION URL” in the update mapping information 711 (S2).

The acquiring unit 701 determines whether or not there is a new version of the firmware (S3). If there is a new version of the firmware (Yes in S3), the acquiring unit 701 determines whether or not the machine number included in the FW update request is included in the FW-update prohibited apparatus list 712 (S11).

If the machine number is not included in the FW-update prohibited apparatus list 712 (No in S11), the transmitting unit 702 transmits file information of the firmware to the apparatus 50B (S4).

If the machine number is included in the FW-update prohibited apparatus list 712 (Yes in S11), the inquiry unit 703 determines whether or not the FW update request is the first FW update request from the apparatus 50B after an update of the update mapping information 711 (S6). The other operations are substantially the same as those in the first exemplary embodiment, and will not be described.

### First Modified Example

In step S5 in the flowcharts in FIGS. 11 and 15, the case, in which a FW update request is transmitted after a predetermined time has elapsed since an update of the update mapping information 711, may be regarded as an exemplary specific case, and an inquiry about whether or not there is a version to which an update is to be done may be transmitted to the management server 3.

### Second Modified Example

In step S5 in the flowcharts in FIGS. 11 and 15, the case, in which a FW update request is the first FW update request from the apparatus 50B, may be regarded as an exemplary specific case, and an inquiry about whether or not there is a version, to which an update is to be done, may be transmitted to the management server 3.

The exemplary embodiments of the present disclosure are described above. The exemplary embodiments of the present disclosure are not limited to those described above. Various changes may be made and embodied.

A part or all of each of the units of the processor 70a may be formed by using a hardware circuit, such as a field programmable gate array (FPGA) or an application specific integrated circuit (ASIC).

In the embodiments above, the term “processor” refers to hardware in a broad sense. Examples of the processor include general processors (e.g., CPU: Central Processing Unit), and dedicated processors (e.g., GPU: Graphics Processing Unit, ASIC, FPGA, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Some of the components according to the exemplary embodiments may be omitted or changed. In the flow in the exemplary embodiments, for example, steps may be added, deleted, changed, and/or replaced. The program used in the exemplary embodiments may be provided by recording the program in a computer-readable recording medium such as a compact disc-read-only memory (CD-ROM), or may be stored in an external server such as a cloud server and may be used over a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed:

1. An information processing apparatus comprising:
a processor configured to,
when an update request to update control information is received from a target apparatus, ask, in a specific case, a management apparatus about whether or not there is the control information for the update request, the management apparatus managing the control information on the Internet.

2. The information processing apparatus according to claim 1,
wherein the processor is configured to
access the management apparatus at regular time intervals,
obtain the control information, and
store and update the control information in a storage unit of the information processing apparatus.

3. The information processing apparatus according to claim 2,
wherein the processor is configured to, when the control information for the update request is stored in the storage unit, transmit storage location information to the target apparatus without asking the management apparatus, the storage location information indicating a storage location of the control information in the storage unit.

4. The information processing apparatus according to claim 2,
wherein the specific case is a case in which the update request is received after a predetermined time elapses since an update of the control information stored in the storage unit.

5. The information processing apparatus according to claim 2,
wherein the storage unit stores update information including identification information of the control information, version information about new and old versions, and information about a storage location of the control information, and
wherein the processor is configured to search the update information on a basis of the identification information of the control information and the version information, the identification information of the control information and the version information being included in the update request, and obtain the corresponding version information about new and old versions and the corresponding storage location information.

6. The information processing apparatus according to claim 3,
wherein the storage unit stores update information including identification information of the control information, version information about new and old versions, and information about the storage location of the control information, and
wherein the processor is configured to search the update information on a basis of the identification information of the control information and the version information, the identification information of the control information and the version information being included in the update request, and obtain the corresponding version information about new and old versions and the corresponding storage location information.

7. The information processing apparatus according to claim 2,
wherein the specific case is a case in which the control information for the update request is not stored in the storage unit and in which a first condition is satisfied, the first condition being that there is no update request from apparatuses other than the update request, the apparatuses having a model identical to a model of the target apparatus.

8. The information processing apparatus according to claim 7,
wherein the processor is configured to, when the first condition is not satisfied but a second condition is satisfied, the second condition being that there is no update request from the target apparatus other than the update request, notify the target apparatus that the update request is invalid.

9. The information processing apparatus according to claim 7,
wherein the processor is configured to, when a second condition is not satisfied, the second condition being that there is no update request from the target apparatus other than the update request, notify the target apparatus or the management apparatus that the update request is invalid.

10. The information processing apparatus according to claim 1,
wherein the processor is configured to, when, as a result of an inquiry to the management apparatus about whether or not there is the control information, it is found that there is the corresponding control information, transmit, to the target apparatus, storage location information of the control information managed by the management apparatus.

11. The information processing apparatus according to claim 1,
wherein, when the target apparatus is a specific apparatus in which an update of the control information is prohibited, even if the management apparatus or the storage unit stores the corresponding control information, the specific apparatus is notified that the update request is invalid.

12. A non-transitory computer readable medium storing a program causing a computer to execute a process comprising:
when an update request to update control information is received from a target apparatus, asking, in a specific case, a management apparatus about whether or not there is the control information for the update request, the management apparatus managing the control information on the Internet.

13. An information processing apparatus comprising:
means for, when an update request to update control information is received from a target apparatus, asking, in a specific case, a management apparatus about whether or not there is the control information for the update request, the management apparatus managing the control information on the Internet.
